(19) United States
(12) Patent Application Publication
(10) Pub. No.: US 2022/0281578 A1
(43) Pub. Date: Sep. 8, 2022

(54) MARINE VESSEL MANEUVERING SYSTEM AND MARINE VESSEL

(71) Applicant: YAMAHA HATSUDOKI KABUSHIKI KAISHA, Iwata-shi (JP)

(72) Inventors: Atsushi MORIE, Shizuoka (JP); Yukitaka OKAMOTO, Shizuoka (JP); Hirofumi AMMA, Shizuoka (JP)

(21) Appl. No.: 17/679,409

(22) Filed: Feb. 24, 2022

(30) Foreign Application Priority Data
Mar. 3, 2021 (JP) 2021-033850

(51) Int. Cl. B63H 21/21; G05D 1/02; B63B 49/00; B63B 79/40; F02D 31/00; B63B 79/30; B63H 11/08

(52) U.S. Cl. CPC B63H 21/21; G05D 1/0206; B63B 49/00; B63B 79/40; F02D 31/009; B63B 79/30; B63H 11/08; B63H 2021/216

(57) ABSTRACT

A marine vessel maneuvering system includes an engine and a controller configured or programmed to control a marine vessel. The controller is configured or programmed to set a control of the engine for each destination based on at least one of information indicating the destination acquired incident to a setting operation of the destination by a distributor or information indicating the destination acquired from a ground-based or sea-based base station at the destination.

### CROSS REFERENCE TO RELATED APPLICATIONS

This application claims the benefit of priority to Japanese Patent Application No. 2021-033850 filed on Mar. 3, 2021. The entire contents of this application are hereby incorporated herein by reference.

### BACKGROUND OF THE INVENTION

### 1. Field of the Invention

The present invention relates to a marine vessel maneuvering system and a marine vessel, and more particularly, it relates to a marine vessel maneuvering system and a marine vessel, both of which include a controller to set an engine control for each destination.

### 2. Description of the Related Art

A marine vessel including a controller to set an engine control for each destination of the marine vessel is known in general. Such a marine vessel is disclosed in Japanese Patent Laid-Open No. 2013-086668, for example.

Japanese Patent Laid-Open No. 2013-086668 discloses a marine vessel including a global navigation satellite system (GNSS) receiver to receive position information of a marine vessel main body, a storage to store position information of a destination, and an engine controller (controller) to control an engine. In the marine vessel disclosed in Japanese Patent Laid-Open No. 2013-086668, the engine controller determines whether the engine is controlled in a control mode of a normal mode or a restricted mode based on whether or not the current position of the marine vessel main body acquired by the GNSS receiver is included in the destination stored in the storage. In the restricted mode, the maximum speed of the marine vessel is restricted, for example, unlike the normal mode. That is, the engine controller sets an engine control for each destination using a GNSS at the destination. Thus, it is not necessary to set the engine control for each destination at the time of shipment from the factory, and thus the specifications of the engine controller at the time of shipment from the factory can be unified.

However, in the marine vessel disclosed in Japanese Patent Laid-Open No. 2013-086668, when the GNSS (global navigation satellite system) is not available, an engine control is not able to be set for each destination. A case in which the GNSS is not available refers to a case in which the GNSS receiver does not receive radio waves from a GNSS satellite due to the influence of the environment around the marine vessel, for example. Therefore, in order to unify the specifications of the engine controller at the time of shipment from the factory, it is desired to set an engine control for each destination without using the GNSS at the destination.

### SUMMARY OF THE INVENTION

Preferred embodiments of the present invention provide marine vessel maneuvering systems and marine vessels that each set an engine control for each destination of the marine vessel without using a global navigation satellite system (GNSS) at the destination in order to unify the specifications of engine controllers at the time of shipment from the factory.

A marine vessel maneuvering system according to a preferred embodiment of the present invention includes an engine and a controller configured or programmed to control a marine vessel, and the controller is configured or programmed to set a control of the engine for each destination of the marine vessel based on at least one of information indicating the destination acquired incident to a setting operation of the destination by a distributor or information indicating the destination acquired from a ground-based or sea-based base station at the destination.

In a marine vessel maneuvering system according to a preferred embodiment of the present invention, the controller is configured or programmed to set the control of the engine for each destination based on at least one of the information indicating the destination acquired incident to the setting operation of the destination by the distributor or the information indicating the destination acquired from the ground-based or sea-based base station at the destination. Accordingly, the controller sets the control of the engine for each destination based on the information indicating the destination acquired without using a global navigation satellite system (GNSS) at the destination. Consequently, in order to unify the specifications of the controller at the time of shipment from the factory, the control of the engine is set for each destination without using the GNSS at the destination.

In a marine vessel maneuvering system according to a preferred embodiment of the present invention, the controller is preferably configured or programmed to set at least one of a control of a maximum speed of the marine vessel or an air-fuel ratio of the engine for each destination based on the information indicating the destination. Accordingly, the controller sets, for each destination, at least one of the control of the maximum speed of the marine vessel with the presence or absence of a restriction differing from destination to destination or the air-fuel ratio of the engine related to the compositions of exhaust gases with a restriction differing from destination to destination based on the information indicating the destination.

In a marine vessel maneuvering system according to a preferred embodiment of the present invention, the information indicating the destination preferably includes at least one of map information or position information, and the controller is preferably configured or programmed to set the control of the engine for each destination based on the at least one of the map information or the position information. Accordingly, the controller easily determines the destination based on at least one of the map information or the position information as the information indicating the destination, and thus the control of the engine is easily set for each destination.

In such a case, the controller is preferably configured or programmed to set the control of the engine for each destination based on the map information installed in the setting operation of the destination by the distributor. Accordingly, unlike a method using the GNSS in which the information indicating the destination may not be acquired, the controller reliably acquires the map information to determine the destination by the operation to install the map information, which is usually performed in the setting operation of the destination by the distributor.

A marine vessel maneuvering system including the controller configured or programmed to set the control of the engine for each destination based on the map information installed in the setting operation of the destination by the distributor preferably further includes a display to display information on the marine vessel including the map information, and the controller is preferably configured or programmed to set the control of the engine for each destination based on the map information installed in the display in the setting operation of the destination by the distributor. Accordingly, a device on which the map information is displayed and a device in which the map information is installed are the same, and thus the device structure is simplified.

A marine vessel maneuvering system including the controller configured or programmed to set the control of the engine for each destination based on the position information preferably further includes a communicator to communicate with the ground-based or sea-based base station, and the controller is preferably configured or programmed to set the control of the engine for each destination based on the position information acquired from the ground-based or sea-based base station at the destination by the communicator. Accordingly, the ground-based or sea-based base station has a much smaller distance from the marine vessel than from a GNSS satellite, and thus the controller more easily acquires the position information to determine the destination from the ground-based or sea-based base station as compared with a case in which the GNSS is used.

In a marine vessel maneuvering system including the controller configured or programmed to set the control of the maximum speed of the marine vessel for each destination based on the information indicating the destination, the controller is preferably configured or programmed to set a maximum speed restriction control to restrict the maximum speed of the marine vessel for each destination based on the information indicating the destination such that the maximum speed restriction control is in an ON state or an OFF state. Accordingly, the controller easily sets the control of the maximum speed of the marine vessel for each destination by automatically setting the maximum speed restriction control for each destination such that the maximum speed restriction control is in the ON state or the OFF state at the destination.

In such a case, the controller is preferably configured or programmed to set the maximum speed restriction control to the ON state or the OFF state for each destination based on the information indicating the destination in a state in which the maximum speed restriction control is not set to either ON or OFF. Accordingly, the controller easily sets the control of the maximum speed of the marine vessel for each destination at the destination when the maximum speed restriction control is not set to either the ON state or the OFF state at the time of shipment from the factory.

In a marine vessel maneuvering system including the controller configured or programmed to set the maximum speed restriction control to restrict the maximum speed of the marine vessel for each destination such that the maximum speed restriction control is in the ON state or the OFF state, the controller is preferably configured or programmed to, in a state in which the maximum speed restriction control is set to ON, maintain the maximum speed restriction control in the ON state when the maximum speed of the marine vessel is restricted at the destination based on the information indicating the destination, and switch the maximum speed restriction control from the ON state to the OFF state when the maximum speed of the marine vessel is not restricted at the destination based on the information indicating the destination, and is preferably configured or programmed to, in a state in which the maximum speed restriction control is set to OFF, maintain the maximum speed restriction control in the OFF state when the maximum speed of the marine vessel is not restricted at the destination based on the information indicating the destination, and switch the maximum speed restriction control from the OFF state to the ON state when the maximum speed of the marine vessel is restricted at the destination based on the information indicating the destination. Accordingly, the controller easily sets the control of the maximum speed of the marine vessel for each destination at the destination when the maximum speed restriction control is set to the ON state or the OFF state at the time of shipment from the factory. Furthermore, when the maximum speed is restricted at a destination where a large number of marine vessels are shipped, the maximum speed restriction control is set to the ON state at the time of shipment from the factory, and when the maximum speed is not restricted at the destination where a large number of marine vessels are shipped, the maximum speed restriction control is set to the OFF state at the time of shipment from the factory such that a process to switch the maximum speed restriction control at the destination where a large number of marine vessels are shipped is omitted, and the control load on the controller is reduced.

A marine vessel maneuvering system including the controller configured or programmed to set the control of the maximum speed of the marine vessel for each destination based on the information indicating the destination preferably further includes an engine controller configured or programmed to control the engine, and the engine controller is preferably configured or programmed to control a rotation speed of the engine to be equal to or less than a predetermined value such that a speed of the marine vessel does not exceed the maximum speed set based on the information indicating the destination. Accordingly, the engine controller controls the rotation speed of the engine to be equal to or less than the predetermined value such that the output of the engine becomes equal to or less than a predetermined value. Thus, the engine is easily controlled such that the speed of the marine vessel does not exceed the maximum speed set based on the information indicating the destination.

In a marine vessel maneuvering system including the controller configured or programmed to set the air-fuel ratio of the engine for each destination based on the information indicating the destination, the controller is preferably configured or programmed to set the air-fuel ratio of the engine for each destination based on the information indicating the destination to meet a restriction of each destination, and control an amount of fuel injected based on the set air-fuel ratio of the engine. Accordingly, the controller controls the amount of fuel injected, which is a parameter to determine the air-fuel ratio of the engine, based on the air-fuel ratio of the engine set to meet the restriction of each destination at the destination.

In a marine vessel maneuvering system including the controller configured or programmed to set the control of the engine for each destination based on the position information, the controller is preferably configured or programmed to set the control of the engine for each destination based on the position information acquired when a failure diagnosis system is connected to perform failure diagnosis of the marine vessel in the setting operation of the destination by the distributor. Accordingly, unlike the method using the GNSS in which the information indicating the destination may not be acquired, the controller reliably acquires the position information to determine the destination by the operation to connect the failure diagnosis system to the marine vessel maneuvering system, which is usually performed in the setting operation of the destination by the distributor.

In a marine vessel maneuvering system according to a preferred embodiment of the present invention, the controller preferably includes an engine controller configured or programmed to control the engine, or a display controller of a display to display information on the marine vessel. Accordingly, the engine controller or the display controller sets the control of the engine for each destination based on the information indicating the destination.

A marine vessel according to a preferred embodiment of the present invention includes a marine vessel main body including an engine, and a controller configured or programmed to control the marine vessel. The controller is configured or programmed to set the control of the engine for each destination of the marine vessel based on at least one of information indicating the destination acquired incident to a setting operation of the destination by a distributor or information indicating the destination acquired from a ground-based or sea-based base station at the destination.

In a marine vessel according to a preferred embodiment of the present invention, similarly to the marine vessel maneuvering system according to preferred embodiments of the present invention described above, the controller is configured or programmed to set the control of the engine for each destination based on at least one of the information indicating the destination acquired incident to the setting operation of the destination by the distributor or the information indicating the destination acquired from the ground-based or sea-based base station at the destination. Accordingly, similarly to the marine vessel maneuvering system according to preferred embodiments of the present invention described above, the controller sets the control of the engine for each destination based on the information indicating the destination acquired without using a global navigation satellite system (GNSS) at the destination. Consequently, similarly to the marine vessel maneuvering system according to preferred embodiments of the present invention described above, in order to unify the specifications of the controller at the time of shipment from the factory, the control of the engine is set for each destination without using the GNSS at the destination.

In a marine vessel according to a preferred embodiment of the present invention, the controller is preferably configured or programmed to set at least one of a control of a maximum speed of the marine vessel or an air-fuel ratio of the engine for each destination based on the information indicating the destination. Accordingly, similarly to the marine vessel maneuvering system according to preferred embodiments of the present invention described above, the controller sets, for each destination, at least one of the control of the maximum speed of the marine vessel with the presence or absence of a restriction differing from destination to destination or the air-fuel ratio of the engine related to the compositions of exhaust gases with a restriction differing from destination to destination based on the information indicating the destination.

In a marine vessel according to a preferred embodiment of the present invention, the information indicating the destination preferably includes at least one of map information or position information, and the controller is preferably configured or programmed to set the control of the engine for each destination based on the at least one of the map information or the position information. Accordingly, similarly to the marine vessel maneuvering system according to preferred embodiments of the present invention described above, the controller easily determines the destination based on at least one of the map information or the position information as the information indicating the destination, and thus the control of the engine is easily set for each destination.

In such a case, the controller is preferably configured or programmed to set the control of the engine for each destination based on the map information installed in the setting operation of the destination by the distributor. Accordingly, similarly to the marine vessel maneuvering system according to preferred embodiments of the present invention described above, unlike a method using the GNSS in which the information indicating the destination may not be acquired, the controller reliably acquires the map information to determine the destination by the operation to install the map information, which is usually performed in the setting operation of the destination by the distributor.

A marine vessel including the controller configured or programmed to set the control of the engine for each destination based on the map information installed in the setting operation of the destination by the distributor preferably further includes a display to display information on the marine vessel including the map information, and the controller is preferably configured or programmed to set the control of the engine for each destination based on the map information installed in the display in the setting operation of the destination by the distributor. Accordingly, similarly to the marine vessel maneuvering system according to preferred embodiments of the present invention described above, a device on which the map information is displayed and a device in which the map information is installed are the same, and thus the device structure is simplified.

A marine vessel including the controller configured or programmed to set the control of the engine for each destination based on the position information preferably further includes a communicator to communicate with the ground-based or sea-based base station, and the controller is preferably configured or programmed to set the control of the engine for each destination based on the position information acquired from the ground-based or sea-based base station at the destination by the communicator. Accordingly, similarly to the marine vessel maneuvering system according to preferred embodiments of the present invention described above, the ground-based or sea-based base station has a much smaller distance from the marine vessel than from a GNSS satellite, and thus the controller more easily acquires the position information to determine the destination from the ground-based or sea-based base station as compared with a case in which the GNSS is used.

A marine vessel according to a preferred embodiment of the present invention preferably further includes a jet thruster to jet water by a driving force from the engine. Accordingly, the controller sets the control of the engine for each destination in the marine vessel including the jet thruster based on the information indicating the destination.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a sectional view schematically showing a marine vessel according to a first preferred embodiment of the present invention.

FIG. 2 is a block diagram showing the structure of a marine vessel maneuvering system according to the first preferred embodiment of the present invention.

FIG. 3 is a schematic view illustrating setting of an engine control for each destination in the marine vessel maneuvering system according to the first preferred embodiment of the present invention.

FIG. 4 is a control flow diagram of setting of an engine control for each destination in the marine vessel maneuvering system according to the first preferred embodiment of the present invention.

FIG. 5 is a schematic view illustrating setting of an engine control for each destination in a marine vessel maneuvering system according to a second preferred embodiment of the present invention.

FIG. 6 is a control flow diagram of setting of an engine control for each destination in the marine vessel maneuvering system according to the second preferred embodiment of the present invention.

FIG. 7 is a schematic view illustrating setting of an engine control for each destination in a marine vessel maneuvering system according to a third preferred embodiment of the present invention.

FIG. 8 is a control flow diagram of setting of an engine control for each destination in the marine vessel maneuvering system according to the third preferred embodiment of the present invention.

FIG. 9 is a schematic view illustrating setting of an engine control for each destination in a marine vessel maneuvering system according to a fourth preferred embodiment of the present invention.

FIG. 10 is a block diagram showing the structure of a marine vessel maneuvering system according to a fifth preferred embodiment of the present invention.

FIG. 11 is a schematic view illustrating setting of an engine control for each destination in the marine vessel maneuvering system according to the fifth preferred embodiment of the present invention.

FIG. 12 is a diagram illustrating a relationship between the air-fuel ratio of an engine and exhaust gases.

FIG. 13 is a control flow diagram of setting of an engine control for each destination in the marine vessel maneuvering system according to the fifth preferred embodiment of the present invention.

### DETAILED DESCRIPTION OF THE PREFERRED EMBODIMENTS

Preferred embodiments of the present invention are hereinafter described with reference to the drawings.

### First Preferred Embodiment

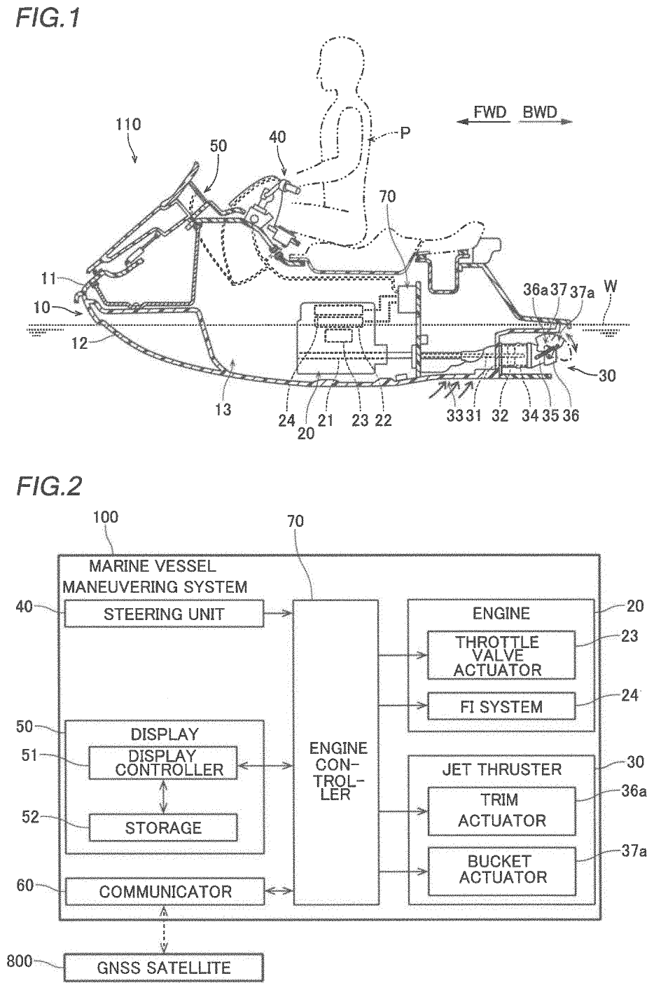

The structure of a marine vessel maneuvering system 100 and the structure of a marine vessel 110 according to a first preferred embodiment of the present invention are now described with reference to FIGS. 1 to 4. The marine vessel maneuvering system 100 maneuvers the marine vessel 110. The marine vessel maneuvering system 100 is provided in the marine vessel 110.

As shown in FIG. 1, the marine vessel 110 is a personal watercraft (PWC), for example. Furthermore, the marine vessel 110 is a water jet propelled boat (wet bike). Arrow FWD and arrow BWD in FIG. 1 represent the front side and the rear side of the marine vessel 110, respectively.

The marine vessel 110 includes a marine vessel main body 10, an engine 20, a jet thruster 30, a steering unit 40, a display 50, a communicator 60, and an engine controller 70.

The marine vessel main body 10 includes a deck 11 that floats on the water surface W and a hull 12 located below the water surface W. An engine room 13 is provided between the deck 11 and the hull 12 to house the engine 20.

The engine 20 obtains a driving force to rotate a crankshaft 21 by burning an air-fuel mixture in a combustion chamber. Specifically, the engine 20 includes a throttle valve 22, a throttle valve actuator 23, and a fuel injection system (FI system) 24.

The opening degree of the throttle valve 22 is changed by the throttle valve actuator 23 such that the throttle valve 22 adjusts the amount of air supplied to the combustion chamber of the engine 20. As the opening degree of the throttle valve 22 increases, the rotation speed of the engine 20 increases. The FI system 24 injects fuel and adjusts the amount of fuel supplied to the combustion chamber. As the amount of fuel supplied to the combustion chamber, the air-fuel ratio (ratio of air to fuel) of the engine 20 increases.

The jet thruster 30 jets water by a driving force from the engine 20. That is, the jet thruster 30 generates a propulsive force to propel the marine vessel main body 10 by driving of the engine 20. Specifically, the jet thruster 30 includes an impeller shaft 31, an impeller 32, a water intake 33, an impeller housing 34, a nozzle 35, a deflector 36, and a bucket 37.

The impeller shaft 31 is connected to the crankshaft 21. The impeller 32 is provided adjacent to or in the vicinity of a rear end of the impeller shaft 31. The impeller 32 is disposed inside the impeller housing 34 connected to a rear portion of the water intake 33, suctions water below the water surface W from the water intake 33, and jets the water rearward from the nozzle 35 provided rearward of the impeller housing 34.

The deflector 36 is disposed rearward of the nozzle 35, and changes the direction of the water jetted rearward from the nozzle 35 to a right-left direction. The orientation of the deflector 36 in the right-left direction is changed by a trim actuator 36a. The orientation of the deflector 36 in the right-left direction is changed such that the marine vessel 110 is steered.

The bucket 37 is movable between the upper side and the rear side of the deflector 36 by a bucket actuator 37a. The bucket 37 changes the direction of the water jetted rearward from the nozzle 35 and the deflector 36 to a forward direction when the bucket 37 is moved to the rear side of the deflector 36.

The steering unit 40 receives an operation of a rider P to steer (maneuver) the marine vessel 110. Specifically, the steering unit 40 includes a throttle operator (a lever, for example) to receive an operation to change the opening degree of the throttle valve 22, a handle (a grip, for example) to receive an operation to change the direction and position of the deflector 36, etc.

As shown in FIG. 2, the steering unit 40 transmits an input operation by the rider P (see FIG. 1) to the engine controller 70. Specifically, the amount of operation on the throttle operator (the rotation angle of the lever, for example) and the amount of operation on the handle (the rotation angle of the grip, for example) are detected, and a detection signal (information on the amount of operation) is transmitted to the engine controller 70.

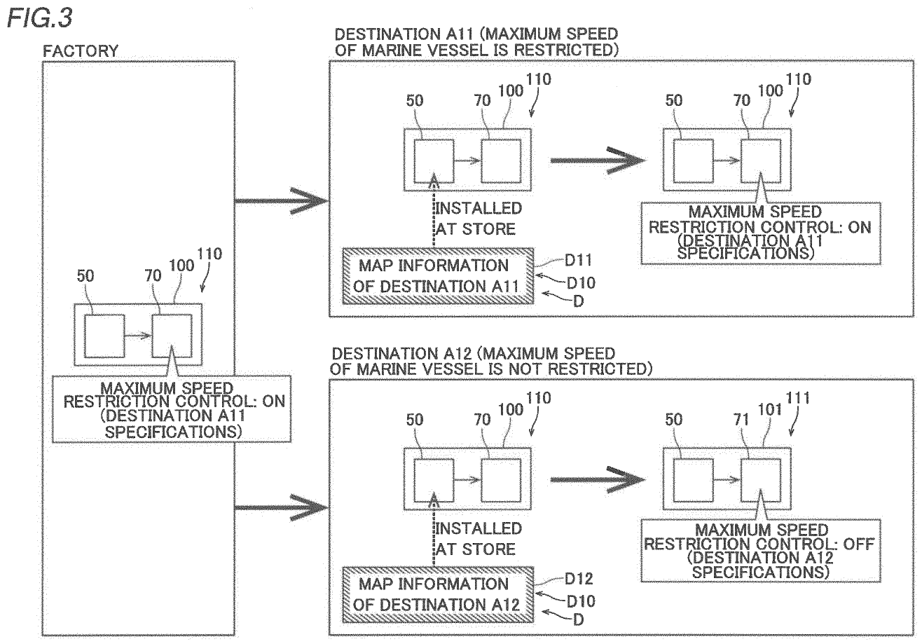

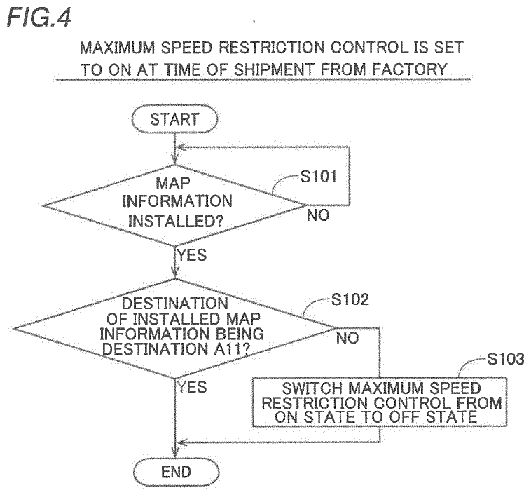

As shown in FIG. 1, the display 50 is disposed adjacent to or in the vicinity (on the front side) of the steering unit 40. The display 50 is disposed at a position visually recognized by the rider P. The display 50 includes a liquid crystal display, for example. The display 50 may include a touch panel. The display 50 displays information on the marine vessel 110. The information on the marine vessel 110 includes the speed of the marine vessel 110, the remaining amount of fuel, and map information D10 (see FIG. 3), for example.

As shown in FIG. 2, the display 50 includes a display controller 51 and a storage 52. The display controller 51 is configured or programmed to control the operation of the display 50. The display controller 51 includes a central processing unit (CPU), a read-only memory (ROM), and a random access memory (RAM), for example. The storage 52 stores a program used for control by the display controller 51, the map information D10 (see FIG. 3), etc.

The communicator 60 communicates with a GNSS satellite 800. The marine vessel 110 (marine vessel maneuvering system 100) obtains the current position of the marine vessel 110 based on information communicated with the GNSS satellite 800 via the communicator 60.

As shown in FIG. 1, the engine controller 70 is housed in the engine room 13. The engine controller 70 controls the marine vessel 110. The engine controller 70 includes a central processing unit (CPU), a read-only memory (ROM), and a random access memory (RAM), for example.

As shown in FIG. 2, the engine controller 70 controls the engine 20. Specifically, the engine controller 70 controls the throttle valve actuator 23 to change the opening degree of the throttle valve 22 (see FIG. 1) based on the amount of operation on the throttle operator transmitted from the steering unit 40. That is, the engine controller 70 controls the throttle valve actuator 23 to change the rotation speed of the engine 20. Further, the engine controller 70 controls the FI system 24 to inject fuel at a predetermined timing.

The engine controller 70 controls the trim actuator 36a such that the orientation of the deflector 36 (see FIG. 1) in the right-left direction is changed based on the amount of operation on the handle transmitted from the steering unit 40. The engine controller 70 controls the bucket actuator 37a to move the bucket 37 (see FIG. 1) between the upper side and the rear side of the deflector 36 based on the amount of operation on the handle transmitted from the steering unit 40.

As shown in FIG. 3, at a destination A11 among destinations to which the marine vessel 110 is shipped, the maximum speed of the marine vessel 110 is restricted. On the other hand, at a destination A12 (a destination other than the destination A11), the maximum speed of the marine vessel 110 is not restricted. Therefore, the engine controller 70 with different specifications is required for each destination.

Therefore, in the first preferred embodiment, the engine controller 70 sets a control of the maximum speed of the marine vessel 110 (a control of the engine 20 (see FIG. 2)) for each destination based on information D indicating a destination acquired incident to a setting operation of the destination by the distributor (e.g., a company at the destination that sells, leases, or rents marine vessels). Specifically, the engine controller 70 sets a maximum speed restriction control to restrict the maximum speed of the marine vessel 110 for each destination based on the information D indicating the destination such that the maximum speed restriction control is in an ON state or an OFF state.

Specifically, the engine controller 70 is set to the destination A11 specifications at the time of shipment from the factory. That is, in the engine controller 70, the maximum speed restriction control is set to ON at the time of shipment from the factory. At a store of each destination (e.g., a store at the destination that sells, leases, or rents marine vessels), various setting operations on the marine vessel maneuvering system 100 are performed by the distributor.

In the first preferred embodiment, the engine controller 70 maintains the maximum speed restriction control in the ON state when the maximum speed of the marine vessel 110 is restricted at the destination based on the information D indicating the destination in a state in which the maximum speed restriction control is set to ON. Thus, the marine vessel maneuvering system 100 (marine vessel 110) including the engine controller 70 of the destination A11 specifications at the time of shipment from the factory is sold as the marine vessel maneuvering system 100 (marine vessel 110) including the engine controller 70 of the destination A11 specifications at the destination A11.

In the first preferred embodiment, the engine controller 70 switches the maximum speed restriction control from the ON state to the OFF state when the maximum speed of the marine vessel 110 is not restricted at the destination based on the information D indicating the destination in a state in which the maximum speed restriction control is set to ON. Thus, the marine vessel maneuvering system 100 (marine vessel 110) including the engine controller 70 of the destination A11 specifications at the time of shipment from the factory is sold as a marine vessel maneuvering system 101 (marine vessel 111) including an engine controller 71 of the destination A12 specifications at the destination A12.

In the first preferred embodiment, the information D indicating the destination includes the map information D10. The engine controller 70 sets a control of the engine 20 for each destination based on the map information D10. Specifically, the engine controller 70 determines that the destination is the destination A11 based on the map information D11 of the destination A11. Furthermore, the engine controller 70 determines that the destination is the destination A12 based on the map information D12 of the destination A12. That is, the engine controller 70 uses the map information D10 of the destination as the information D indicating the destination.

In the first preferred embodiment, the engine controller 70 sets a control of the engine 20 for each destination based on the map information D10 acquired by being installed in the display 50 in the setting operation of the destination by the distributor. Specifically, at a store of each destination, the distributor installs the map information D10 in the display 50. The map information D10 is installed in the display 50 via a universal serial bus (USB), for example. When the map information D10 is installed in the display 50, the display controller 51 (see FIG. 2) stores the map information D10 in the storage 52 (see FIG. 2), and transmits information indicating that the map information D10 of the destination has been installed to the engine controller 70. The engine controller 70 determines which destination map information D10 has been installed in the display 50 based on the map information D10 transmitted from the display 50.

In the first preferred embodiment, the engine controller 70 controls the rotation speed of the engine 20 to be equal to or less than a predetermined value such that the speed of the marine vessel 110 does not exceed the maximum speed set based on the information D indicating the destination. Specifically, the engine controller 70 of the destination A11 specifications with the maximum speed restriction control of the marine vessel 110 being set to ON controls the rotation speed of the engine 20 to be equal to or less than the predetermined value such that the speed of the marine vessel 110 does not exceed the maximum speed at the destination A11.

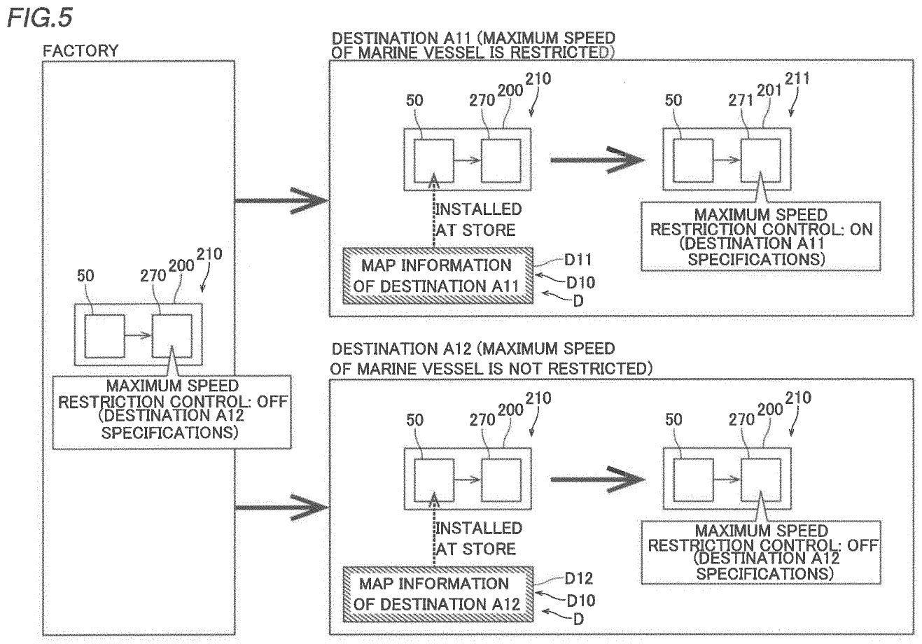

A control flow of setting a control of the engine 20 for each destination by the engine controller 70 is now described with reference to FIG. 4.

In step S101, the engine controller 70 determines whether or not the map information D10 has been installed. When the engine controller 70 determines that the map information D10 has been installed, the engine controller 70 advances to step S102. The engine controller 70 repeats the operation in step S101 until it determines that the map information D10 has been installed.

In step S102, the engine controller 70 determines whether or not the destination of the installed map information D10 is the destination A11. When determining in step S102 that it is the destination A11, the engine controller 70 terminates the control flow while maintaining the maximum speed restriction control in the ON state. When determining in step S102 that it is not the destination A11 (is the destination A12), the engine controller 70 advances to step S103.

In step S103, the engine controller 70 switches the maximum speed restriction control from the ON state to the OFF state. Then, the engine controller 70 terminates the control flow.

According to the first preferred embodiment of the present invention, the following advantageous effects are achieved.

According to the first preferred embodiment of the present invention, the marine vessel maneuvering system 100 (marine vessel 110) includes the engine controller 70 configured or programmed to control the engine 20. The engine controller 70 is configured or programmed to set a control of the engine 20 for each destination based on the information D indicating the destination acquired incident to the setting operation of the destination by the distributor. Accordingly, the engine controller 70 sets a control of the engine 20 for each destination based on the information D indicating the destination acquired without using a global navigation satellite system (GNSS) at the destination. Consequently, in order to unify the specifications of the engine controller 70 at the time of shipment from the factory, a control of the engine 20 is set for each destination without using the GNSS at the destination.

According to the first preferred embodiment of the present invention, the engine controller 70 is configured or programmed to set a control of the maximum speed of the marine vessel 110 for each destination based on the information D indicating the destination. Accordingly, the engine controller 70 sets the control of the maximum speed of the marine vessel 110 with the presence or absence of a restriction differing from destination to destination for each destination based on the information D indicating the destination.

According to the first preferred embodiment of the present invention, the information D indicating the destination includes the map information D10. Furthermore, the engine controller 70 is configured or programmed to set a control of the engine 20 for each destination based on the map information D10. Accordingly, the engine controller 70 easily determines the destination based on the map information D10 as the information D indicating the destination, and thus a control of the engine 20 is easily set for each destination.

According to the first preferred embodiment of the present invention, the engine controller 70 is configured or programmed to set a control of the engine 20 for each destination based on the map information D10 acquired by being installed in the setting operation of the destination by the distributor. Accordingly, unlike a method using the GNSS in which the information D indicating the destination may not be acquired, the engine controller 70 reliably acquires the map information D10 to determine the destination by the operation to install the map information D10, which is usually performed in the setting operation of the destination by the distributor.

According to the first preferred embodiment of the present invention, the marine vessel maneuvering system 100 (marine vessel 110) includes the display 50 to display the information on the marine vessel 110 including the map information D10. Furthermore, the engine controller 70 is configured or programmed to set a control of the engine 20 for each destination based on the map information D10 acquired by being installed in the display 50 in the setting operation of the destination by the distributor. Accordingly, a device on which the map information D10 is displayed and a device in which the map information D10 is installed are the same, and thus the device structure is simplified.

According to the first preferred embodiment of the present invention, the engine controller 70 is configured or programmed to set the maximum speed restriction control to restrict the maximum speed of the marine vessel 110 for each destination based on the information D indicating the destination such that the maximum speed restriction control is in the ON state or the OFF state. Accordingly, the engine controller 70 easily sets the control of the maximum speed of the marine vessel 110 for each destination by automatically setting the maximum speed restriction control for each destination such that the maximum speed restriction control is in the ON state or the OFF state at the destination.

According to the first preferred embodiment of the present invention, the engine controller 70 is configured or programmed to, in a state in which the maximum speed restriction control is set to ON, maintain the maximum speed restriction control in the ON state when the maximum speed of the marine vessel 110 is restricted at the destination based on the information D indicating the destination, and switch the maximum speed restriction control from the ON state to the OFF state when the maximum speed of the marine vessel 110 is not restricted at the destination based on the information D indicating the destination. Accordingly, the engine controller 70 easily sets the control of the maximum speed of the marine vessel 110 for each destination at the destination when the maximum speed restriction control is set to ON at the time of shipment from the factory. Furthermore, when the maximum speed is restricted at a destination where a large number of marine vessels 110 are shipped, the maximum speed restriction control is set to ON at the time of shipment from the factory such that a process to switch the maximum speed restriction control at the destination where a large number of marine vessels 110 are shipped is omitted, and the control load on the engine controller 70 is reduced.

According to the first preferred embodiment of the present invention, the engine controller 70 is configured or programmed to control the rotation speed of the engine 20 to be equal to or less than the predetermined value such that the speed of the marine vessel 110 does not exceed the maximum speed set based on the information D indicating the destination. Accordingly, the engine controller 70 controls the rotation speed of the engine 20 to be equal to or less than the predetermined value such that the output of the engine 20 becomes equal to or less than a predetermined value. Thus, the engine 20 is easily controlled such that the speed of the marine vessel 110 does not exceed the maximum speed set based on the information D indicating the destination.

According to the first preferred embodiment of the present invention, the marine vessel maneuvering system 100 (marine vessel 110) includes the jet thruster 30 to jet water by the driving force from the engine 20. Accordingly, the engine controller 70 sets a control of the engine 20 for each destination in the marine vessel 110 including the jet thruster 30 based on the information D indicating the destination.

### Second Preferred Embodiment

The structure of a marine vessel maneuvering system 200 and the structure of a marine vessel 210 according to a second preferred embodiment of the present invention are now described with reference to FIGS. 2, 5, and 6. In the second preferred embodiment, a maximum speed restriction control is set to OFF at the time of shipment from the factory, unlike the first preferred embodiment in which the maximum speed restriction control is set to ON at the time of shipment from the factory. In the figures, the same or similar structures as those of the marine vessel maneuvering system 100 and the marine vessel 110 according to the first preferred embodiment are denoted by the same reference numerals.

As shown in FIG. 5, the marine vessel maneuvering system 200 (marine vessel 210) includes an engine controller 270 configured or programmed to control an engine 20 (see FIG. 2).

Similarly to the engine controller 70 according to the first preferred embodiment, the engine controller 270 sets a control of the maximum speed of the marine vessel 210 (a control of the engine 20 (see FIG. 2)) for each destination based on information D indicating a destination acquired incident to a setting operation of the destination by the distributor.

Unlike the engine controller 70 according to the first preferred embodiment, the engine controller 270 is set to the destination A12 specifications at the time of shipment from the factory. That is, in the engine controller 270, the maximum speed restriction control is set to OFF at the time of shipment from the factory.

In the second preferred embodiment, the engine controller 270 switches the maximum speed restriction control from an OFF state to an ON state when the maximum speed of the vessel 210 is restricted at the destination based on the information D indicating the destination in a state in which the maximum speed restriction control is set to OFF. Thus, the marine vessel maneuvering system 200 (marine vessel 210) including the engine controller 270 of the destination A12 specifications at the time of shipment from the factory is sold as a ship maneuvering system 201 (marine vessel 211) including an engine controller 271 of the destination A11 specifications at a destination A11.

The engine controller 270 is configured or programmed to maintain the maximum speed restriction control in the OFF state when the maximum speed of the marine vessel 210 is not restricted at the destination based on the information D indicating the destination in a state in which the maximum speed restriction control is set to OFF. Thus, the marine vessel maneuvering system 200 (marine vessel 210) including the engine controller 270 of the destination A12 specifications at the time of shipment from the factory is sold as the marine vessel maneuvering system 200 (marine vessel 210) including the engine controller 270 of the destination A12 specifications at a destination A12.

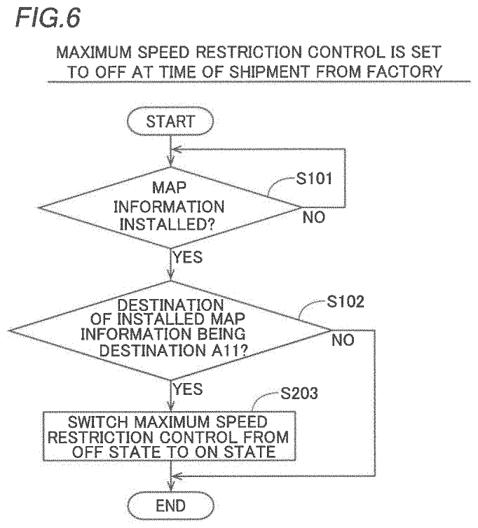

A control flow of setting a control of the engine 20 for each destination by the engine controller 270 is now described with reference to FIG. 6.

In step S102, the engine controller 270 determines whether or not the destination of installed map information D10 is the destination A11. When determining in step S102 that it is the destination A11, the engine controller 270 advances to step S203. When determining in step S102 that it is not the destination A11 (it is the destination A12), the engine controller 270 terminates the control flow while maintaining the maximum speed restriction control in the OFF state.

In step S203, the engine controller 70 switches the maximum speed restriction control from the OFF state to the ON state. Then, the engine controller 270 terminates the control flow.

The remaining structures of the second preferred embodiment are similar to those of the first preferred embodiment.

According to the second preferred embodiment of the present invention, the following advantageous effects are achieved.

According to the second preferred embodiment of the present invention, the engine controller 270 is configured or programmed to, in a state in which the maximum speed restriction control is set to OFF, maintain the maximum speed restriction control in the OFF state when the maximum speed of the marine vessel 210 is not restricted at the destination based on the information D indicating the destination, and switch the maximum speed restriction control from the OFF state to the ON state when the maximum speed of the marine vessel 210 is restricted at the destination based on the information D indicating the destination. Accordingly, the engine controller 270 easily sets the control of the maximum speed of the marine vessel 210 for each destination at the destination when the maximum speed restriction control is set to OFF at the time of shipment from the factory. Furthermore, when the maximum speed is not restricted at a destination where a large number of marine vessels 210 are shipped, the maximum speed restriction control is set to OFF at the time of shipment from the factory such that a process to switch the maximum speed restriction control at the destination where a large number of marine vessels 210 are shipped is omitted, and the control load on the engine controller 270 is reduced.

The remaining advantageous effects of the second preferred embodiment are similar to those of the first preferred embodiment.

### Third Preferred Embodiment

The structure of a marine vessel maneuvering system 300 and the structure of a marine vessel 310 according to a third preferred embodiment of the present invention are now described with reference to FIGS. 2, 7, and 8. In the third preferred embodiment, a maximum speed restriction control is not set to either ON or OFF at the time of shipment from the factory, unlike the first preferred embodiment in which the maximum speed restriction control is set to ON at the time of shipment from the factory and the second preferred embodiment in which the maximum speed restriction control is set to OFF at the time of shipment from the factory. In the figures, the same or similar structures as those of the marine vessel maneuvering system 100 and the marine vessel 110 according to the first preferred embodiment are denoted by the same reference numerals.

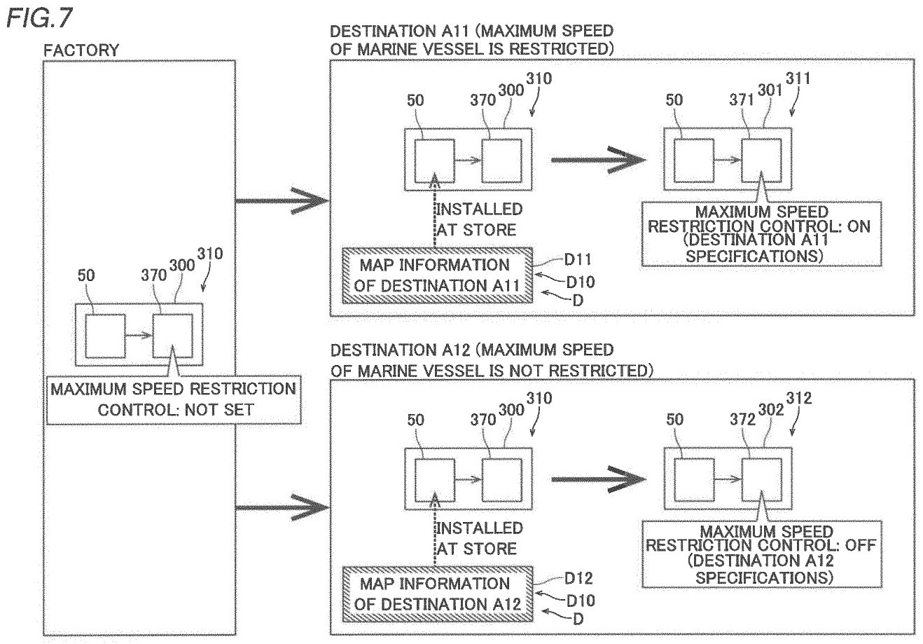

As shown in FIG. 7, the marine vessel maneuvering system 300 (marine vessel 310) includes an engine controller 370 configured or programmed to control an engine 20 (see FIG. 2).

Similarly to the engine controller 70 according to the first preferred embodiment, the engine controller 370 sets a control of the maximum speed of the marine vessel 310 (a control of the engine 20 (see FIG. 2)) for each destination based on information D indicating a destination acquired incident to a setting operation of the destination by the distributor.

Unlike the engine controller 70 according to the first preferred embodiment, the engine controller 370 is not set to either the destination A11 specifications or the destination A12 specifications at the time of shipment from the factory. That is, in the engine controller 370, the maximum speed restriction control is not set to either ON or OFF at the time of shipment from the factory.

In the third preferred embodiment, the engine controller 370 sets the maximum speed restriction control to ON or OFF for each destination based on the information D indicating the destination in a state in which the maximum speed restriction control is not set to either ON or OFF. Thus, the marine vessel maneuvering system 300 (marine vessel 310) including the engine controller 370 that is not set to either the destination A11 specifications or the destination A12 specifications at the time of shipment from the factory is sold as a ship maneuvering system 301 (marine vessel 311) including an engine controller 371 of the destination A11 specifications at a destination A11. Furthermore, the marine vessel maneuvering system 300 (marine vessel 310) including the engine controller 370 that is not set to either the destination A11 specifications or the destination A12 specifications at the time of shipment from the factory is sold as a ship maneuvering system 302 (marine vessel 312) including an engine controller 372 of the destination A12 specifications at a destination A12.

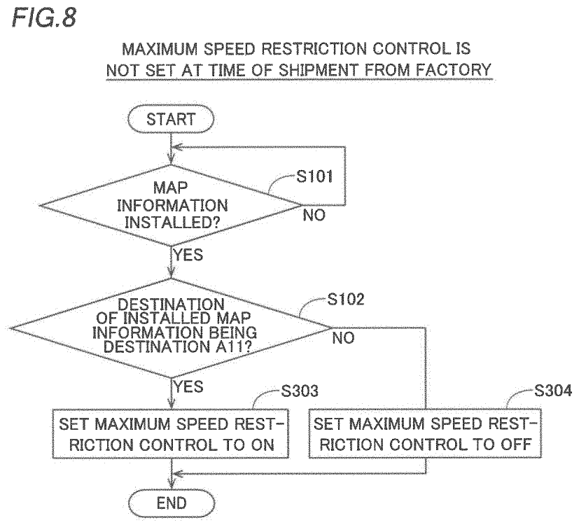

A control flow of setting a control of the engine 20 for each destination by the engine controller 370 is now described with reference to FIG. 8.

In step S102, the engine controller 370 determines whether or not the destination of installed map information D10 is the destination A11. When determining in step S102 that it is the destination A11, the engine controller 370 advances to step S303. When determining in step S102 that it is not the destination A11 (it is the destination A12), the engine controller 370 advances to step S304.

In step S303, the engine controller 370 sets the maximum speed restriction control to ON. Then, the engine controller 370 terminates the control flow.

In step S304, the engine controller 370 sets the maximum speed restriction control to OFF. Then, the engine controller 370 terminates the control flow.

The remaining structures of the third preferred embodiment are similar to those of the first preferred embodiment.

According to the third preferred embodiment of the present invention, the following advantageous effects are achieved.

According to the third preferred embodiment of the present invention, the engine controller 370 is configured or programmed to set the maximum speed restriction control to ON or OFF for each destination based on the information D indicating the destination in a state in which the maximum speed restriction control is not set to either ON or OFF. Accordingly, the engine controller 370 easily sets the control of the maximum speed of the marine vessel 310 for each destination at the destination when the maximum speed restriction control is not set to either ON or OFF at the time of shipment from the factory.

The remaining advantageous effects of the third preferred embodiment are similar to those of the first preferred embodiment.

### Fourth Preferred Embodiment

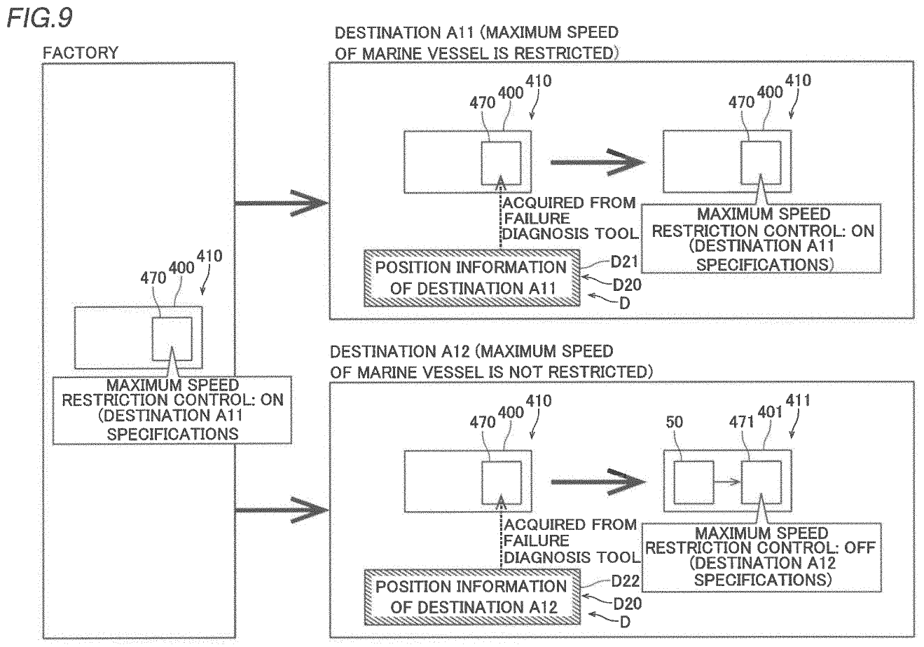

The structure of a marine vessel maneuvering system 400 and the structure of a marine vessel 410 according to a fourth preferred embodiment of the present invention are now described with reference to FIGS. 2 and 9. In the fourth preferred embodiment, position information D20 acquired when a failure diagnosis system is connected is used as information D indicating a destination, unlike the first preferred embodiment in which the map information D10 acquired by being installed is used as the information D indicating the destination. In the figures, the same or similar structures as those of the marine vessel maneuvering system 100 and the marine vessel 110 according to the first preferred embodiment are denoted by the same reference numerals.

As shown in FIG. 9, the marine vessel maneuvering system 400 (marine vessel 410) includes an engine controller 470 configured or programmed to control an engine 20 (see FIG. 2).

Similarly to the engine controller 70 according to the first preferred embodiment, the engine controller 470 sets a control of the maximum speed of the marine vessel 410 (a control of the engine 20 (see FIG. 2)) for each destination based on information D indicating a destination acquired incident to a setting operation of the destination by the distributor.

In the fourth preferred embodiment, the information D indicating the destination includes the position information D20. The engine controller 470 sets a control of the engine 20 for each destination based on the position information D20. Specifically, the engine controller 470 determines that the destination is a destination A11 based on the position information D21 of the destination A11. Furthermore, the engine controller 470 determines that the destination is a destination A12 based on the position information D22 of the destination A12. That is, the engine controller 470 uses the position information D20 of the destination as the information D indicating the destination.

In the fourth preferred embodiment, the engine controller 470 sets a control of the engine 20 for each destination based on the position information D20 acquired when the failure diagnosis system is connected to perform failure diagnosis of the marine vessel 410 in the setting operation of the destination by the distributor. Specifically, at a store of each destination, the distributor connects the failure diagnosis system to the engine controller 470 to perform failure diagnosis of the marine vessel 410. When the failure diagnosis system is connected to the engine controller 470, the failure diagnosis system transmits the position information D20 of the destination to the engine controller 470. Then, the engine controller 470 determines whether or not the destination of the position information D20 is the destination A11 (whether it is the destination A11 or the destination A12) based on the position information D20 transmitted from the failure diagnosis system.

The marine vessel maneuvering system 400 (marine vessel 410) including the engine controller 470 of the destination A11 specifications at the time of shipment from the factory is sold as the marine vessel maneuvering system 400 (marine vessel 410) including the engine controller 470 of the destination A11 specifications at the destination A11. The marine vessel maneuvering system 400 (marine vessel 410) including the engine controller 470 of the destination A11 specifications at the time of shipment from the factory is sold as a marine vessel maneuvering system 401 (marine vessel 411) including an engine controller 471 of the destination A12 specifications at the destination A12.

The remaining structures of the fourth preferred embodiment are similar to those of the first preferred embodiment.

According to the fourth preferred embodiment of the present invention, the following advantageous effects are achieved.

According to the fourth preferred embodiment of the present invention, the information D indicating the destination includes the position information D20. Furthermore, the engine controller 470 is configured or programmed to set a control of the engine 20 for each destination based on the position information D20. Accordingly, the engine controller 470 easily determines the destination based on the position information D20 as the information D indicating the destination, and thus a control of the engine 20 is easily set for each destination.

According to the fourth preferred embodiment of the present invention, the engine controller 470 is configured or programmed to set a control of the engine 20 for each destination based on the position information D20 acquired when the failure diagnosis system is connected to perform failure diagnosis of the marine vessel 410 in the setting operation of the destination by the distributor. Accordingly, unlike a method using a GNSS in which the information D indicating the destination may not be acquired, the engine controller 470 reliably acquires the position information D20 to determine the destination by the operation to connect the failure diagnosis system to the marine vessel maneuvering system 400, which is usually performed in the setting operation of the destination by the distributor.

The remaining advantageous effects of the fourth preferred embodiment are similar to those of the first preferred embodiment.

### Fifth Preferred Embodiment

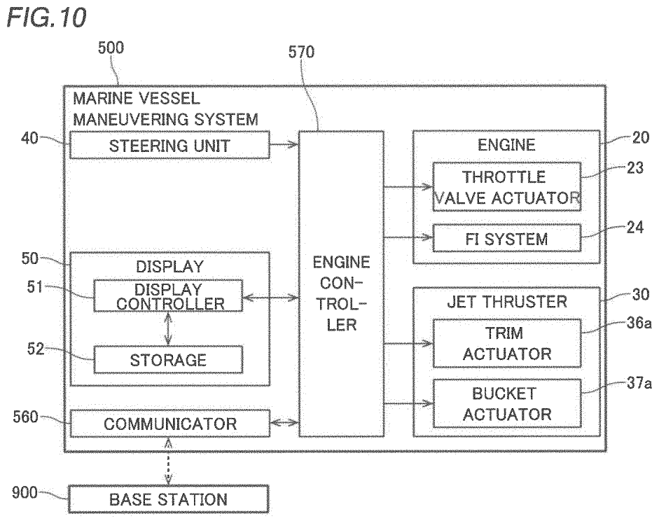

The structure of a marine vessel maneuvering system 500 and the structure of a marine vessel 510 according to a fifth preferred embodiment of the present invention are now described with reference to FIGS. 10 to 13. In the fifth preferred embodiment, position information D30 acquired from a ground-based or sea-based base station 900 at a destination is used as information D indicating the destination, unlike the first preferred embodiment in which the map information D10 acquired incident to the setting operation of the destination by the distributor is used as the information D indicating the destination. In the figures, the same or similar structures as those of the marine vessel maneuvering system 100 and the marine vessel 110 according to the first preferred embodiment are denoted by the same reference numerals.

As shown in FIG. 10, a marine vessel maneuvering system 500 includes an engine controller 570 configured or programmed to control an engine 20.

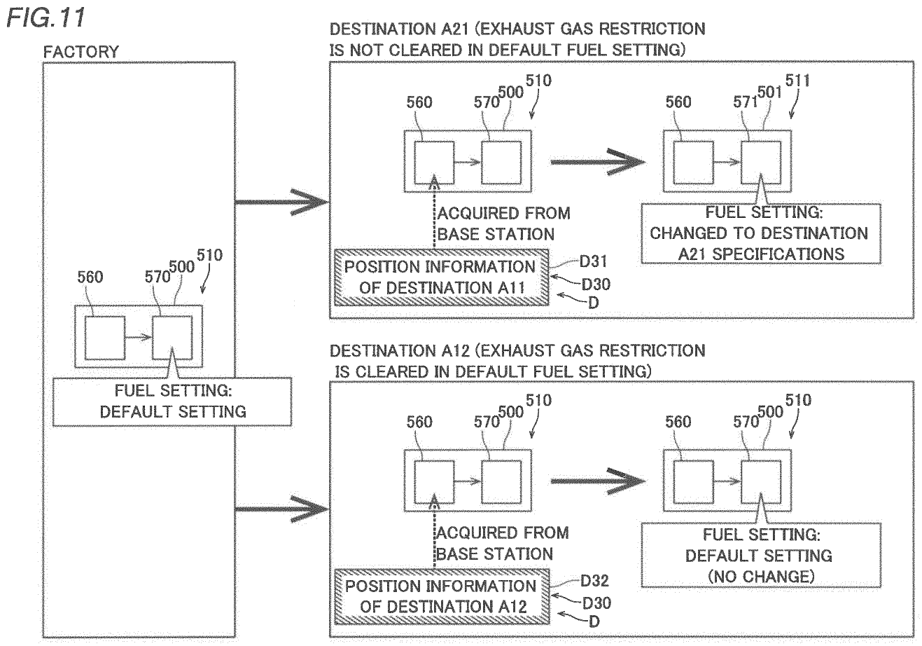

The marine vessel maneuvering system 500 includes a communicator 560. The communicator 560 communicates with the ground-based or sea-based base station 900. The marine vessel maneuvering system 500 obtains the current position of the marine vessel 510 (see FIG. 11) based on information communicated with the base station 900 via the communicator 560.

As shown in FIG. 11, at a destination A11 among destinations to which the marine vessel 510 is shipped, exhaust gas restriction is not cleared in a default fuel setting (the amount of fuel injected by an FI system (see FIG. 10)). On the other hand, at a destination A22 (a destination other than the destination A21), exhaust gas restriction is cleared in the default fuel setting. Therefore, the engine controller 570 with different specifications is required for each destination. The destination A22 is an example of a destination at which exhaust gas restriction is not cleared in the default fuel setting.

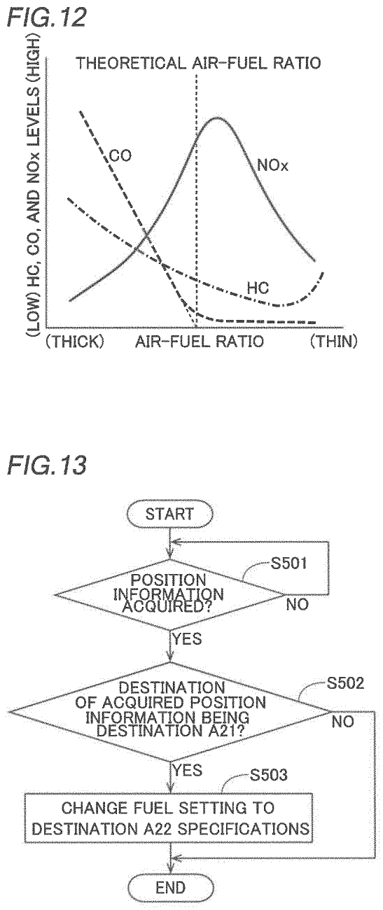

As shown in FIG. 12, exhaust gases from the engine 20 (see FIG. 10) mainly contain HC, CO, and NOx. The amounts (levels) of discharge of HC, CO, and NOx differ depending on the air-fuel ratio of the engine 20. The air-fuel ratio of the engine 20 is changed by adjusting the amount of fuel injected by the FI system (see FIG. 10). That is, the air-fuel ratio of the engine 20 is changed such that the amounts of discharge of exhaust gases are changed.

Therefore, as shown in FIG. 11, in the fifth preferred embodiment, the engine controller 570 sets the air-fuel ratio of the engine 20 (see FIG. 10) (a control of the engine 20) for each destination based on the information D indicating the destination acquired from the ground-based or sea-based base station 900 at the destination. Specifically, the engine controller 570 sets the air-fuel ratio of the engine 20 for each destination based on the information D indicating the destination to meet the restriction of each destination.

Specifically, the engine controller 570 is set to the destination A22 specifications at the time of shipment from the factory. That is, the engine controller 570 is set to the default fuel setting at the time of shipment from the factory.

When the exhaust gas restriction is not cleared in the default fuel setting based on the information D indicating the destination acquired from the base station 900 at each destination (the destination is the destination A21), the engine controller 570 changes the fuel setting.

When the exhaust gas restriction is cleared in the default fuel setting (the amount of fuel injected) based on the information D indicating the destination acquired from the base station 900 at each destination (the destination is the destination A22), the engine controller 570 does not change the fuel setting.

In the fifth preferred embodiment, the engine controller 570 sets a control of the engine 20 for each destination based on the position information D30 as the information D indicating the destination. Specifically, the engine controller 570 determines that the destination is the destination A21 based on the position information D31 of the destination A21. Furthermore, the engine controller 570 determines that the destination is the destination A22 based on the position information D32 of the destination A22. That is, the engine controller 570 uses the position information D30 as the information D indicating the destination.

In the fifth preferred embodiment, the information D indicating the destination includes the position information D30. The engine controller 570 sets a control of the engine 20 for each destination based on the position information D30 acquired from the ground-based or sea-based base station 900 at the destination by the communicator 560. Specifically, at each destination, the engine controller 570 controls the communicator 560 to acquire the position information D30 from the ground-based or sea-based base station 900 at the destination. Then, the engine controller 570 determines which destination is the destination of the acquired position information D30 based on the position information D30 acquired from the base station 900 by the communicator 560.

The marine vessel maneuvering system 500 (marine vessel 510) including the engine controller 570 of the destination A22 specifications at the time of shipment from the factory is sold as a marine vessel maneuvering system 501 (marine vessel 511) including an engine controller 571 of the destination A21 specifications at the destination A21. Furthermore, the marine vessel maneuvering system 500 (marine vessel 510) including the engine controller 570 of the destination A22 specifications at the time of shipment from the factory is sold as the marine vessel maneuvering system 500 (marine vessel 510) including the engine controller 570 of the destination A22 specifications at the destination A22.

In the fifth preferred embodiment, the engine controller 570 controls the amount of fuel injected based on the air-fuel ratio of the engine 20 set for each destination. Specifically, at the destination A21, the engine controller 571, in which the fuel setting (the amount of fuel injected) has been changed from the default to the destination A21 specifications, injects fuel based on the changed fuel setting. Furthermore, at the destination A22, the engine controller 570 of the destination A22 specifications, in which the fuel setting (the amount of fuel injected) is in a default state, injects fuel based on the default fuel setting.

A control flow of setting a control of the engine 20 for each destination by the engine controller 570 is now described with reference to FIG. 13.

In step S501, the engine controller 570 determines whether or not the position information D30 has been acquired. When determining that the position information D30 has been acquired, the engine controller 570 advances to step S502. The engine controller 570 repeats step S501 until it determines that the position information D30 has been acquired.

In step S502, the engine controller 570 determines whether or not the destination of the acquired position information D30 is the destination A21. When determining in step S502 that the destination of the acquired position information D30 is the destination A21, the engine controller 570 advances to step S503. When determining in step S502 that the destination of the acquired position information D30 is not the destination A21 (it is the destination A22), the engine controller 570 does not change the fuel setting from the default setting, and terminates the control flow.

In step S503, the engine controller 570 changes the fuel setting from the default (destination A21 specifications) setting to the destination A22 specifications setting. Then, the engine controller 70 terminates the control flow.

The remaining structures of the fifth preferred embodiment are similar to those of the first preferred embodiment.

According to the fifth preferred embodiment of the present invention, the following advantageous effects are achieved.

According to the fifth preferred embodiment of the present invention, the marine vessel maneuvering system 500 (marine vessel 510) includes the engine controller 570 configured or programmed to control the engine 20. Furthermore, the engine controller 570 is configured or programmed to set a control of the engine 20 for each destination based on the information D indicating the destination acquired from the ground-based or sea-based base station 900 at the destination. Accordingly, similarly to the first preferred embodiment, the engine controller 570 sets a control of the engine 20 for each destination based on the information D indicating the destination acquired without using a GNSS (global navigation satellite system) at the destination. Consequently, similarly to the first preferred embodiment, in order to unify the specifications of the engine controller 570 at the time of shipment from the factory, a control of the engine 20 is set for each destination without using the GNSS at the destination.

According to the fifth preferred embodiment of the present invention, the engine controller 570 is configured or programmed to set the air-fuel ratio of the engine 20 for each destination based on the information D indicating the destination. Accordingly, the engine controller 570 sets, for each destination, the air-fuel ratio of the engine 20 related to an exhaust gas component having a different restriction for each destination based on the information D indicating the destination.

According to the fifth preferred embodiment of the present invention, the information D indicating the destination includes the position information D30. Furthermore, the engine controller 570 is configured or programmed to set a control of the engine 20 for each destination based on the position information D30. Accordingly, the engine controller 570 easily determines the destination based on the position information D30 as the information D indicating the destination, and thus a control of the engine 20 is easily set for each destination.

According to the fifth preferred embodiment of the present invention, the marine vessel maneuvering system 500 (marine vessel 510) includes the communicator 560 to communicate with the ground-based or sea-based base station 900. Furthermore, the engine controller 570 is configured or programmed to set a control of the engine 20 for each destination based on the position information D30 acquired from the ground-based or sea-based base station 900 at the destination by the communicator 560. Accordingly, the ground-based or sea-based base station 900 has a much smaller distance from the marine vessel 510 than from a GNSS satellite, and thus the engine controller 570 more easily acquires the position information D30 to determine the destination from the ground-based or sea-based base station 900 as compared with a case in which the GNSS is used.

According to the fifth preferred embodiment of the present invention, the engine controller 570 is configured or programmed to set the air-fuel ratio of the engine 20 for each destination based on the information D indicating the destination to meet the restriction of each destination, and control the amount of fuel injected based on the set air-fuel ratio of the engine 20. Accordingly, the engine controller 570 controls the amount of fuel injected, which is a parameter to determine the air-fuel ratio of the engine 20, based on the air-fuel ratio of the engine 20 set to meet the restriction of each destination at the destination.

The remaining advantageous effects of the fifth preferred embodiment are similar to those of the first preferred embodiment.

The preferred embodiments of the present invention described above are illustrative in all points and not restrictive. The extent of the present invention is not defined by the above description of the preferred embodiments but by the scope of the claims, and all modifications within the meaning and range equivalent to the scope of the claims are further included.

For example, while each of the marine vessel maneuvering systems 100, 200, 300, 400, and 500 (i.e., the marine vessels 110, 210, 310, 410, and 510) is preferably a water jet propelled boat (wet bike) including the jet thruster 30 to jet water by the driving force from the engine 20 and a personal watercraft (PWC) in each of the first to fifth preferred embodiments described above, the present invention is not restricted to this. In the present invention, the marine vessel maneuvering system (i.e., the marine vessel) may alternatively be an outboard motor boat including an outboard motor as a marine propulsion unit to rotate a propeller by a driving force from an engine to generate a propulsive force.

While the engine controller 470 preferably sets a control of the engine 20 for each destination based on the position information D20 acquired when the failure diagnosis system is connected to perform failure diagnosis of the marine vessel 410 in the setting operation of the destination by the distributor in the fourth preferred embodiment described above, the present invention is not restricted to this. In the present invention, the engine controller may alternatively set a control of the engine for each destination based on map information acquired when the failure diagnosis system is connected in the setting operation of the destination by the distributor.

While each of the engine controllers 70, 270, and 370 preferably sets a control of the engine 20 for each destination based on the map information D10 in each of the first to third preferred embodiments described above, and the engine controller 470 and 570 preferably set a control of the engine 20 for each destination based on the position information D20 and D30 in each of the fourth and fifth preferred embodiments described above, the present invention is not restricted to this. In the present invention, the engine controller may alternatively set a control of the engine for each destination based on both the map information and the position information.

While each of the engine controllers 70, 270, 370, and 470 preferably sets a control of the maximum speed of the marine vessel 110 for each destination based on the information D indicating the destination in each of the first to fourth preferred embodiments described above, and the engine controller 570 preferably sets the air-fuel ratio of the engine 20 for each destination based on the information D indicating the destination in the fifth preferred embodiment described above, the present invention is not restricted to this. In the present invention, the engine controller may alternatively set both the control of the maximum speed of the marine vessel and the air-fuel ratio of the engine for each destination based on the information indicating the destination.

While each of the engine controllers 70, 270, 370, and 470 preferably sets a control of the engine 20 for each destination based on the information D indicating the destination acquired incident to the setting operation of the destination by the distributor in each of the first to fourth preferred embodiments described above, and the engine controller 570 preferably sets a control of the engine 20 for each destination based on the information D indicating the destination acquired from the ground-based or sea-based base station 900 at the destination in the fifth preferred embodiment described above, the present invention is not restricted to this. In the present invention, the engine controller may alternatively set a control of the engine for each destination based on both the information indicating the destination acquired incident to the setting operation of the destination by the distributor and the information indicating the destination acquired from the ground-based or sea-based base station at the destination.

While each of the engine controllers 70, 270, 370, 470, and 570 preferably sets a control of the engine 20 for each destination based on the information D indicating the destination in each of the first to fifth preferred embodiments described above, the present invention is not restricted to this. In the present invention, the display controller of the display may alternatively set a control of the engine for each destination based on the information indicating the destination. In such a case, the engine controller acquires information on a control of the engine set for each destination from the display and controls the engine, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A marine vessel maneuvering system comprising:
an engine; and
a controller configured or programmed to control a marine vessel; wherein
the controller is configured or programmed to set a control of the engine for each destination of the marine vessel based on at least one of information indicating the destination acquired incident to a setting operation of the destination by a distributor or information indicating the destination acquired from a ground-based or sea-based base station at the destination.

2. The marine vessel maneuvering system according to claim 1, wherein the controller is configured or programmed to set at least one of a control of a maximum speed of the marine vessel or an air-fuel ratio of the engine for each destination based on the information indicating the destination.

3. The marine vessel maneuvering system according to claim 1, wherein
the information indicating the destination includes at least one of map information or position information; and
the controller is configured or programmed to set the control of the engine for each destination based on the at least one of the map information or the position information.

4. The marine vessel maneuvering system according to claim 3, wherein the controller is configured or programmed to set the control of the engine for each destination based on the map information installed in the setting operation of the destination by the distributor.

5. The marine vessel maneuvering system according to claim 4, further comprising:
a display to display information on the marine vessel including the map information; wherein
the controller is configured or programmed to set the control of the engine for each destination based on the map information installed in the display in the setting operation of the destination by the distributor.

6. The marine vessel maneuvering system according to claim 3, further comprising:
a communicator to communicate with the ground-based or sea-based base station; wherein
the controller is configured or programmed to set the control of the engine for each destination based on the position information acquired from the ground-based or sea-based base station at the destination by the communicator.

7. The marine vessel maneuvering system according to claim 2, wherein the controller is configured or programmed to set a maximum speed restriction control to restrict the maximum speed of the marine vessel for each destination based on the information indicating the destination such that the maximum speed restriction control is in an ON state or an OFF state.

8. The marine vessel maneuvering system according to claim 7, wherein the controller is configured or programmed to set the maximum speed restriction control to the ON state or the OFF state for each destination based on the information indicating the destination in a state in which the maximum speed restriction control is not set to either ON or OFF.

9. The marine vessel maneuvering system according to claim 7, wherein
the controller is configured or programmed to, in a state in which the maximum speed restriction control is ON, maintain the maximum speed restriction control in the ON state when the maximum speed of the marine vessel is restricted at the destination based on the information indicating the destination, and switch the maximum speed restriction control from the ON state to the OFF state when the maximum speed of the marine vessel is not restricted at the destination based on the information indicating the destination; and
the controller is configured or programmed to, in a state in which the maximum speed restriction control is set to OFF, maintain the maximum speed restriction control in the OFF state when the maximum speed of the marine vessel is not restricted at the destination based on the information indicating the destination, and switch the maximum speed restriction control from the OFF state to the ON state when the maximum speed of the marine vessel is restricted at the destination based on the information indicating the destination.

10. The marine vessel maneuvering system according to claim 2, further comprising:
an engine controller configured or programmed to control the engine; wherein
the engine controller is configured or programmed to control a rotation speed of the engine to be equal to or less than a predetermined value such that a speed of the marine vessel does not exceed the maximum speed set based on the information indicating the destination.

11. The marine vessel maneuvering system according to claim 2, wherein the controller is configured or programmed to set the air-fuel ratio of the engine for each destination based on the information indicating the destination to meet a restriction of each destination, and control an amount of fuel injected based on the set air-fuel ratio of the engine.

12. The marine vessel maneuvering system according to claim 3, wherein the controller is configured or programmed to set the control of the engine for each destination based on the position information acquired when a failure diagnosis system is connected to perform failure diagnosis of the marine vessel in the setting operation of the destination by the distributor.

13. The marine vessel maneuvering system according to claim 1, wherein the controller includes an engine controller configured or programmed to control the engine, or a display controller of a display to display information on the marine vessel.

14. A marine vessel comprising:
a marine vessel main body including an engine; and
a controller configured or programmed to control the marine vessel; wherein
the controller is configured or programmed to set the control of the engine for each destination of the marine vessel based on at least one of information indicating the destination acquired incident to a setting operation of the destination by a distributor or information indicating the destination acquired from a ground-based or sea-based base station at the destination.

15. The marine vessel according to claim 14, wherein the controller is configured or programmed to set at least one of a control of a maximum speed of the marine vessel or an air-fuel ratio of the engine for each destination based on the information indicating the destination.

16. The marine vessel according to claim 14, wherein
the information indicating the destination includes at least one of map information or position information; and
the controller is configured or programmed to set the control of the engine for each destination based on the at least one of the map information or the position information.

17. The marine vessel according to claim 16, wherein the controller is configured or programmed to set the control of the engine for each destination based on the map information installed in the setting operation of the destination by the distributor.

18. The marine vessel according to claim 17, further comprising:
a display to display information on the marine vessel including the map information; wherein
the controller is configured or programmed to set the control of the engine for each destination based on the map information installed in the display in the setting operation of the destination by the distributor.

19. The marine vessel according to claim 16, further comprising:
a communicator to communicate with the ground-based or sea-based base station; wherein
the controller is configured or programmed to set the control of the engine for each destination based on the position information acquired from the ground-based or sea-based base station at the destination by the communicator.

20. The marine vessel according to claim 14, further comprising:
a jet thruster to jet water by a driving force from the engine.
